(19) United States
(12) Patent Application Publication
(10) Pub. No.: US 2008/0257812 A1
(43) Pub. Date: Oct. 23, 2008

(54) Jet Loop Wastewater Treatment System

(75) Inventor: Antonio Manuel Cardoso Marques Ferreira, Torres Vedras (PT)

Correspondence Address: SUGHRUE MION, PLLC, 2100 PENNSYLVANIA AVENUE, N.W., SUITE 800, WASHINGTON, DC, 20037, US

(73) Assignee: Tecnia Processos E Equipmentos Industriais E Ambintais, Torres Vedras (PT)

(21) Appl. No.: 12/089,873

(22) PCT Filed: Oct. 10, 2005
(86) PCT No.: PCT/PT2005/000017

§ 371 Date: Apr. 10, 2008

(30) Foreign Application Priority Data
Oct. 10, 2005 (PT) 103366

(51) Int. Cl. C02F 3/02; B01F 5/04

(52) U.S. Cl. 210/218; 210/220

(57) ABSTRACT

The current invention is referred to a process for biological wastewater treatment. One or more ejectors pump atmospheric oxygen in a bioreactor by aspirating air. The innovative concept of the system relies on the installation of the ejector (s) over and outside of the liquid to be treated at the bioreactor. The operation of the system consists basically in one centrifugal pump per ejector, that pumps the effluent through the ejector, creating with the effluent the liquid motor that aspires air in specific points of the ejector. The ejector (s) are used for bioreactors having a minimum depth of 7.5 m and a draft tube inside. The ejector is characterized by a set of non moving pieces (2), an ejection cup, an aspiration section, a superior conic section of mixing air/liquid, a tubular acceleration section and, an inferior expansion zone. The ejector generates a ratio of aspirated air to motion liquid equal or superior to 2.5 (volume/volume). This ratio beats the counter pressure generated by the liquid in the bioreactor. The ejector operates with the Venturi principles.

The current patent is referred a new and revolutionary process for biological wastewater treatment, using atmospheric oxygen as source for oxidation of the raw organic loads. The oxygen is pumped together with air, into a bioreactor by aspiration of the air in ejector(s). The innovative concept of the system relies on the installation of the advanced designed ejector(s) over and outside of the liquid to be treated at the bioreactor. The operation of the system consists basically in one centrifugal pump per ejector that pumps the effluent through the ejector, creating with the effluent the liquid motor that aspires the air in specific points of the ejector. The assembling of the specially advanced and unique designed ejector(s) into the position above the liquid and the use of bioreactor(s) with a minimum of 7.5 m deep, including a draft tube for discharge in the bottom of the bioreactor(s), allow for a total length of passage of the air trough the liquid not less than 15 m.

The result from this retention time of air into the effluent, together with the perfect mixing of the extremely small micro bubbles of air with the liquid, creates the most effective and the highest diffusion coefficient of oxygen into the water until now.

Measured values of Kla (Coefficient for global oxygen transfer) in Jet-Loop Systems operating with high charged effluents raise up to 0.9 min-1, thus very close to the theoretical maximum admitted.

The SOTR (Standard Oxygen Transfer Rate) observed in similar conditions is reported as 4.6 Kg O2/KW. This is the most efficient device in terms of energy, for oxygen transfer from air to the liquid known until the moment.

The dissolved oxygen concentration at the effluent is, in result of the high Kla and SOTR, very high, and it was measure in several conditions, and was reported to be always above 55% of the saturation concentration, and in general DO concentrations were observed as high as 5-6 mg/L DO.

Due to the high DO (Dissolved Oxygen) concentrations, the system handles perfectly with VOC (Volatile Organic Compounds) witch usually is released by wastewater influents, like ammonia, oxidizing those components strongly and limiting its emissions below insignificant levels. This advantage is adequate for elimination of odors in the wastewater treatment plants and the near surroundings.

The aerobic treatment at the bioreactor is enhanced by the high concentration of active biomass together with the higher concentrations of dissolved oxygen yet seen. The passage of the liquid through the ejector at high pressure followed by sudden expansion and the additional sheer stress friction, allow for the destruction of most of the sludge in the process, thus reducing the excess sludge to a minimum. The destruction of the sludge inside the aerobic process is enhanced by the sludge age increase, obtained by the recirculation of all the sludge exiting in the process, by separation.

The Jet Loop system is constituted by a tank (1) that represents the bioreactor shell, a centrifugal pump responsible by the circulation of the motion liquid (effluent), an ejector assembled in the top of the bioreactor that is responsible for the aspiration of atmospheric air, a de gasifier to remove the excess of air in the effluent, and two pipes, one inside the tank that transports the mixture air/liquid in to the bottom of the tank, and another that establishes the contact between the ejector and the centrifugal pump.

From a general point of view, the effluent that comes out of the bioreactor as an excess of air, and due to this, it is necessary to remove the air from the liquid, this is accomplished by the de gasifier. The effluent is then recirculated to the bioreactor by the centrifugal pump, that leads the effluent in to the ejector, allowing the aspiration of atmospheric air. This mixture air/liquid is transported by a pipe assembled inside the bioreactor and is discharged in the bottom of the bioreactor.

The ejector is characterized by a set of non moving pieces (2) namely top flange, ejection cup, an aspiration pipe a superior cone of mixing air/liquid, an acceleration pipe and, an inferior expansion cone. The ejector was developed to generate a volume of aspirated air in to the motion liquid with a relation (atmospheric air/motion liquid) equal or superior to 2.5 (volume/volume) and, simultaneously beat the counter pressure generated by the liquid in the bioreactor. This is achieved with a diameter ratio (D1/D2) equal to: 2.25, and a length ratio L1/L2 equal or minor than 0.2.

Each one of the parts that integrate the ejector as a different function, the top flange allows to establish the connection between the ejector and the pipe that comes from the pump and that transports the motion liquid (effluent, the ejection cup is responsible by the increase in the liquid velocity through the reduction of the passage area, this cup is connected to a mixing cone that promotes the mixture of both fluids air/liquid. The increase in the liquid velocity provokes the aspiration of atmospheric air trough the aspiration pipe. Connected to this cone we have an acceleration pipe so that the velocity of the mixture is maintained and to avoid the return of the liquid on the aspiration pipe, the part that finishes the ejector is an expansion cone, to increase the velocity of the mixture air/liquid. The ejector is connected to a transport pipe, by a flange, this pipe leads the mixture inside the bioreactor, this mixture is responsible by the waste water aeration.

Following a more detailed explanation is given by the aid of the annex drawings.

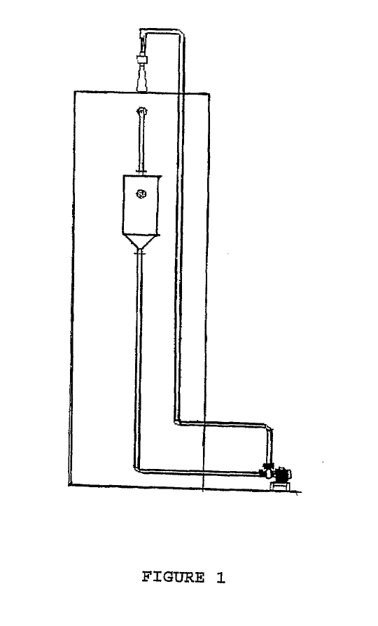

The FIG. 1 illustrates a lateral view of the Jet Loop system.

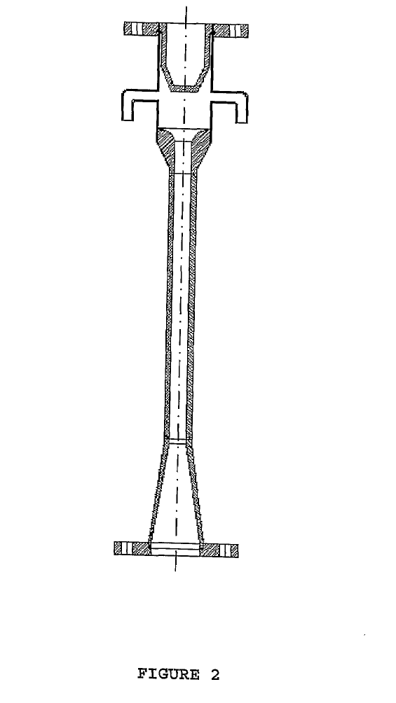

The FIG. 2 illustrates the ejector.

With reference to the annex drawings, the FIG. 1 generically represents the jet loop system for the aerobic treatment of liquid effluents. As can be seen in the figure the Jet Loop System is constituted by a cylindrical tank designated by reactor shell. Coupled to the reactor tank we have a de gasifier that removes the excess of gas accumulated in the liquid (effluent). The de gasifier establishes the connection with the centrifugal pump, by a pipe. The ejector is the equipment represented in the FIG. 2, it is constituted by a set of fix pieces of exclusive design and it as an innovative assembly as the installation is done outside the liquid, allowing the aspiration of atmospheric air. On the ejector is connected a pipe trough which the mixture gas/liquid is transported inside the reactor and in to its bottom, where the mixture is released allowing its dispersion.

1. System for the biological treatment of industrial and domestic effluents with the same principles as those that use activated aerobic sludge, using as a source for oxidation of the raw organic loads the atmospheric oxygen contained in the air, which is pumped into a reactor 1 by aspiration of the air through ejectors 2, characterised in that the said ejectors 2 are installed at the top of the reactor 1 above the level of the effluent and in that the air/effluent mixture is taken to the bottom of the reactor through a tube 5.

2. System for the biological treatment of effluents, according to the preceding claim, characterised in that the air bubbles which rise through the reactor are partially, together with the effluent, aspirated by a degasifier 3 placed inside the reactor 1, the said degasifier being connected by a tube 15 to a centrifugal pump 4 and its function being to remove the air from the effluent.

3. System for the biological treatment of effluents, according to the previous claims, characterised in that the liquid effluent is pumped by one or more centrifugal pumps 4 through the ejector(s) 2, causing the aspiration of the atmospheric air.

4. System for the biological treatment of effluents, according to claim 1, characterised in that the reactor 1 has a minimum depth of 7.5 m and includes a discharge tube 5 which takes the air/effluent mixture from the ejector 2 to the bottom of the reactor, making it possible to obtain an air passage in the effluent of at least 15 m.

5. System for the biological treatment of effluents, according to the previous claims, characterised in that the global oxygen transfer coefficient can be 0.9 min⁻¹.

6. System for the biological treatment of effluents, according to the previous claims, characterised in that the standard oxygen transfer rate is 4.6 O₂/KW.

7. System for the biological treatment of effluents, according to the previous claims, characterised in that the oxygen concentration is greater than 55% of the saturation concentration, being around 5-6 mg/L of dissolved oxygen.

8. System for the biological treatment of effluents, according to claims 1 and 7, characterised in that the ejector is dimensioned to generate a volume of air aspirated into the effluent liquid with a volume/volume ratio equal to or greater than 2.5 and to simultaneously overcome the counterpressure of the liquid inside the reactor.

9. System for the biological treatment of effluents, according to claim 8, characterised in that in the ejector the ratio of the diameter of the entry section of the ejector D1 to the diameter of the acceleration zone D2 is equal to 2.25 and the ratio of the length of the entry zone corresponding to the diameter D1 to the length of the entry zone corresponding to the diameter D2 is equal to or lower than 0.2.

10. System for the biological treatment of effluents, according to claims 8 and 9, characterised in that the passage of the liquid through the injector at high pressure followed by sudden expansion, together with the friction caused by the ejector, ensures the fragmentation of the biomass, reducing it to a minimum.
